(19) United States
(12) Patent Application Publication
(10) Pub. No.: US 2026/0202695 A1
(43) Pub. Date: Jul. 16, 2026

(54) SOLID STATE OPTICAL CAVITIES WITH THIN FILM LITHIUM NIOBATE LAYER FOR RESONANCE TUNING

(71) Applicant: NTT RESEARCH, INC., SUNNYVALE, CA (US)

(72) Inventors: Thibault CHERVY, SUNNYVALE, CA (US); Puneet A. MURTHY, SUNNYVALE, CA (US)

(73) Assignee: NTT RESEARCH, INC., SUNNYVALE, CA (US)

(21) Appl. No.: 19/129,970

(22) PCT Filed: Nov. 16, 2023
(86) PCT No.: PCT/US2023/080035

§ 371 Date: May 14, 2025

Related U.S. Application Data
(60) Provisional application No. 63/425,730, filed on Nov. 16, 2022.

(51) Int. Cl. G02F 1/03; H04J 14/02

(52) U.S. Cl. CPC G02F 1/0311; G02F 1/0316; H04J 14/0307; G02F 2203/02

(57) ABSTRACT

A solid state optical cavity may include a first mirror and a second mirror providing reflective surfaces for light to reflect back and forth within the cavity to create a standing wave at a resonant frequency. A thin film lithium niobate layer may be deposited between the first mirror and the second mirror. The thin film lithium niobate layer may be configured to be electrically tunable to optically select the resonant frequency.

### CROSS REFERENCE TO RELATED APPLICATIONS

This application claims priority to U.S. Provisional Application No. 63/425,730, filed Nov. 16, 2022, which is hereby incorporated by reference in its entirety.

### FIELD

This disclosure relates to optical cavities, and more particularly to solid state optical cavities with thin film niobate layers for resonance tuning.

### BACKGROUND

Optical cavities (also known as optical resonators or resonating cavities) generate a standing wave of light using reflective surfaces. An optical cavity becomes frequency selective based on its geometry—the optical cavity's dimensions cause a selection of a particular frequency to generate a standing wave through constructive interferences, while cancelling out other frequencies through destructive interferences. The selected frequency is known as a resonance frequency.

Variable optical cavities, where the corresponding resonant frequencies may be changed, may be desired for different practical applications. For instance, the same cavity may be desired to generate radiations of different frequencies at different points in time. Conventional processes of generating variable optical cavities involve mechanical movements: a piezoelectric actuator is used to move one reflective surface to vary the distance between the two reflective surfaces.

However, the mechanical movement based frequency variation is size limiting and cumbersome. The piezoelectric actuator necessarily has a minimum size, e.g., in the order of millimeters and centimeters. This minimum size puts a constraint on miniaturization—while the other properties of the optical cavity may be used to make it smaller, accommodating the relatively bulky piezoelectric actuator means that the optical cavity should be kept at or above a certain size. A mechanical motion furthermore provides its own tuning challenges—it may be technically difficult to achieve a desired precise movement. Moving parts also mean that the optical cavities are prone to mechanical malfunctions and failures.

### SUMMARY

In some embodiments, a solid state optical cavity may be provided. The solid state optical cavity may include a first mirror and a second mirror providing reflective surfaces for light to reflect back and forth within the cavity to create a standing wave at a resonant frequency. A thin film lithium niobate layer may be in between the first mirror and the second mirror. The thin film lithium niobate layer may be configured to be electrically tunable to optically select the resonant frequency.

In some embodiments, an optical encoder for wavelength division multiplexing may be provided. The optical encoder may include a plurality of solid state optical cavities for corresponding resonant wavelengths. Each of the plurality of solid state cavities may include a first mirror and a second mirror providing reflective surfaces for light to reflect back and forth within the solid state optical cavity to create a standing wave for a corresponding resonant wavelength, and a thin film lithium niobate layer in between the first mirror and the second mirror. The thin film lithium niobate layer may be configured to be electrically tunable to optically select the corresponding resonant wavelength. Different signals may be encoded at the corresponding different wavelengths to provide the wavelength division multiplexing.

In some embodiments, an optical decoder for decoding signals with wavelength division multiplexing may be provided. The optical decoder may include a plurality of solid state optical cavities for corresponding resonant wavelengths. Each of the plurality of solid state cavities may include a first mirror and a second mirror providing reflective surfaces for light to reflect back and forth within the solid state optical cavity to create a standing wave for a corresponding resonant wavelength, and a thin film lithium niobate layer in between the first mirror and the second mirror. The thin film lithium niobate layer may be configured to be electrically tunable to optically select the corresponding resonant wavelength. The wavelength division multiplexed signals may be decoded at corresponding different wavelengths.

In some embodiments, a spectrometer may be provided. The spectrometer may include a plurality of solid state optical cavities for corresponding resonant wavelengths. Each of the plurality of solid state optical cavities may include a first mirror and a second mirror providing reflective surfaces for light to reflect back and forth within the solid state optical cavity to create a standing wave for a corresponding resonant wavelength, and a thin film lithium niobate layer in between the first mirror and the second mirror. The thin film lithium niobate layer may be configured to be electrically tunable to optically select the corresponding resonant wavelength. The corresponding resonant wavelengths may be configured to be used in a wavelength sweep to measure spectral features of a source.

### BRIEF DESCRIPTION OF DRAWINGS

FIG. 1 shows an example optical cavity, according to example embodiments of this disclosure.

FIG. 2 shows a graph illustrating tunability of an optical cavity, according to the example embodiments of this disclosure.

FIG. 3 shows an optical encoding and decoding system using optical cavities, according to the example embodiments of this disclosure.

FIG. 4 shows an example high resolution spectrometer, according to example embodiments of this disclosure.

The FIGURES are for purposes of illustrating example embodiments, but it is understood that the present disclosure is not limited to the arrangements and instrumentality shown in the drawings. In the figures, identical reference numbers identify at least generally similar elements.

### DESCRIPTION

Embodiments described herein solve the technical problems of conventional technology and may provide other solutions as well. In the disclosed examples, frequency selection in an optical cavity may be provided by changing optical properties of materials between reflective surfaces (e.g., mirrors) of the optical cavity. For instance, a thin film lithium niobate may be deposited in one of the reflective surfaces. Electrical terminals may be provided on the thin film niobate through which electrical signals are provided to precisely control the optical properties of the lithium niobate. The electrical signals may influence the orientation of the covalent bonds within the lithium niobate to generate the desired optical properties. Therefore, using no mechanical movements, optical cavities with controllable resonant frequencies may be provided in solid state with a smaller form factor. Example uses of these solid state, non-mechanical, and miniaturized optical cavities include encoders and decoders for optical communications with dense wavelength division multiplexing, high resolution spectrometry, and the like.

Because of the lack of a bulky piezoelectric actuator and moving parts, the optical cavities according to example embodiments may be miniaturized with lesser constraints compared to those having moving parts. For example, multiple optical cavities may be formed within a single die, where the multiple cavities may perform as encoders and/or decoders in optical communication. As another example, the multiple cavities may perform as a high resolution spectrometer with a large yet significantly granular wavelength/frequency sweep. Owing to its miniaturized size, a chip with multiple optical cavities may be swapped out for other conventional bulky encoder/decoders and/or spectrometers.

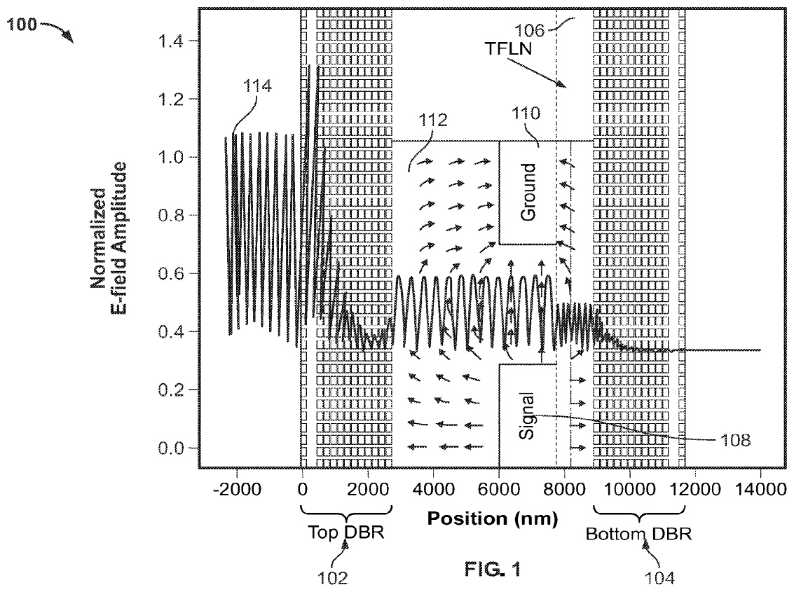

FIG. 1 shows an example optical cavity 100, according to example embodiments of this disclosure. As shown, the optical cavity 100 may include, among other components, a first mirror 102 (also referred to a top distributed Bragg reflector, DBR), a second mirror 104 (also referred to as a bottom DBR), and a thin film lithium niobate 106 layer on the second mirror 104. It should however be understood that the components of the optical cavity 100 shown in FIG. 1 and described herein are merely examples, and optical cavities with additional, alternate, and fewer number of components should be considered within the scope of this disclosure.

One of more of the first mirror 102 and the second mirror 104 may be made of any reflective material and/or layers of reflective materials. As shown, each of the first mirror 102 and the second mirror 104 may be a DBR.

The thin film lithium niobate 106 may be deposited on at least one of the first mirror 102 and the second mirror 104. In some embodiments, such as that shown in FIG. 1, the thin film lithium niobate 106 is deposited on the second mirror 104. In some embodiments, the thin film niobate may be deposited in between the mirrors 102, 104 (e.g., within a dielectric 112) or on both mirrors 102, 104. Generally, the thin film lithium niobate 106 can be deposited/positioned at any location within the optical cavity 100 to generate the desired optical properties through an application of electrical signals. The dielectric 112 may formed of transparent material that may allow the light 114 to pass without causing a change in optical properties. For instance, the dielectric may be formed of silicon dioxide.

To impart the electrical signals on the thin film lithium niobate 106, a signal electrode 108 and a ground electrode 110 may be used. Signals may be provided through the electrodes 108, 110 as electrical potentials. Based on these signals, the electrical properties of the thin film lithium niobate may change, e.g., the orientations of the covalent bonds may change, and the change in electrical properties may cause changes in the optical properties. The changed optical properties may then generate a frequency resonance for a light 114 (or any other form of electromagnetic radiation) passing through the optical cavity 100.

In operation, the resonance is based on change of the wavelength and also a change in the speed of the light 114. The light 114 may have multiple wavelengths and frequencies. Each wavelength of the light 114 may decrease as the light 114 passes through the thin film lithium niobate 106. This decrement may be controlled by changing the signal in the electrodes 108, 110. Such decrement may cause constructive interference of the light 114 to occur in one wavelength as the light 114 moves back and forth between the mirrors 102, 104; wherein other wavelengths may destructively interfere and cancel out each other. Therefore, only a particular wavelength of the light 114 is selected (e.g., only the corresponding frequency may resonate) within the optical cavity.

In some embodiments, changing the electrical properties of the thin film lithium niobate 106 may cause the thin film lithium niobate 106 to operate as a lens. The lens operation may be based on the electrical field, generated by the electrical signals through electrodes 108, 110 while not being uniformly applied across the thin film lithium niobate. Therefore, in addition to being wavelength (and frequency) selective, the thin film lithium niobate 106 may change the direction of the light 114 (it should be noted that the change in direction may also be wavelength/frequency selective). The lens-like properties may be used when the light 114 is not incident perpendicular (i.e., normal direction) to the mirrors 102, 104. Such non-perpendicular incidence may cause the light 114 to escape the optical cavity 100 after a few reflections back and forth, but the thin film lithium niobate 106 may avoid that problem by bending the light 114 as desired.

Therefore, an optical cavity may be realized in solid state without the use of moving parts using the embodiments disclosed herein. Furthermore, significant miniaturization is possible compared to the conventional systems. There are no bulky moving parts and the change in resonating frequency can be done simply by changing the electrical signal (in the form of electrical potential) applied across the thin film lithium niobate 106. Furthermore, because there are multiple movements of the light 114 back and forth in the cavity, large lithium niobate crystals may not be needed. A thin film (as shown) with thinner crystals may cause incremental changes to the light 114, and the incremental changes may compound over time to realize the desired resonance.

The optical cavity 100 may further be relatively easy to fabricate. The mirrors 102, 104, the dielectric 112, and the thin film lithium niobate 106 may be deposited in layers. Then, portions of the thin film lithium niobate 106 may be evaporated, and these portions may be used for depositing/installing the electrodes 108, 110.

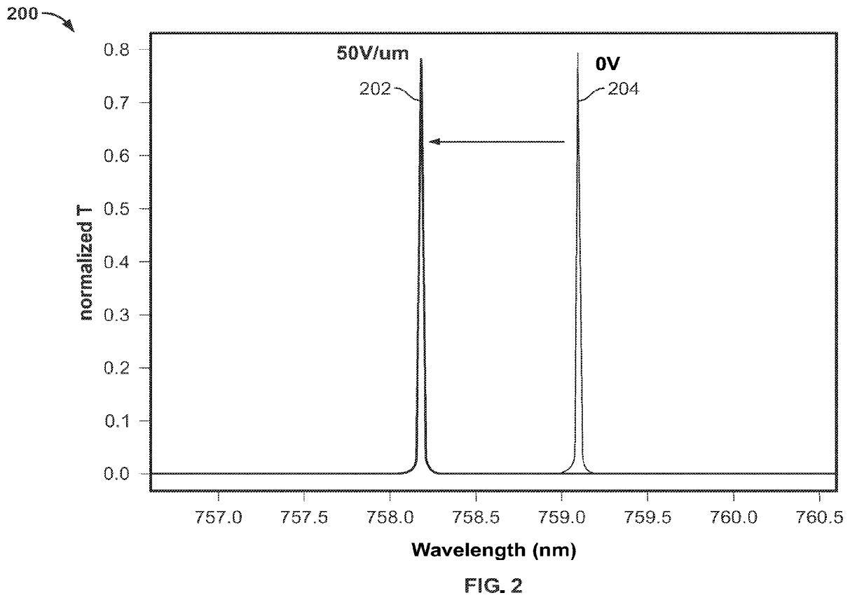

FIG. 2 shows a graph 200 illustrating tunability of an optical cavity, according to the example embodiments of this disclosure. The specific tuning shown in the graph 200 is just an example and should not be considered limiting. In the graph 200, showing an electrically tunable transmission spectrum, curve 204 shows the resonant wavelength (with a corresponding resonance frequency) when a 0 volt signal is applied to the electrodes in thin film lithium niobate. As shown, the curve 204 is narrow indicating the precision of tuning of the optical cavity. Curve 202 shows the resonant wavelength when a signal of 50 V/micrometer is applied to the optical cavity. The curve 202 is also narrow and precise, and the shift between the resonant wavelengths are precise, and achieved without the use of any moving parts.

The optical cavities based on the embodiments herein may have several different uses. Some non-limiting examples uses are described below.

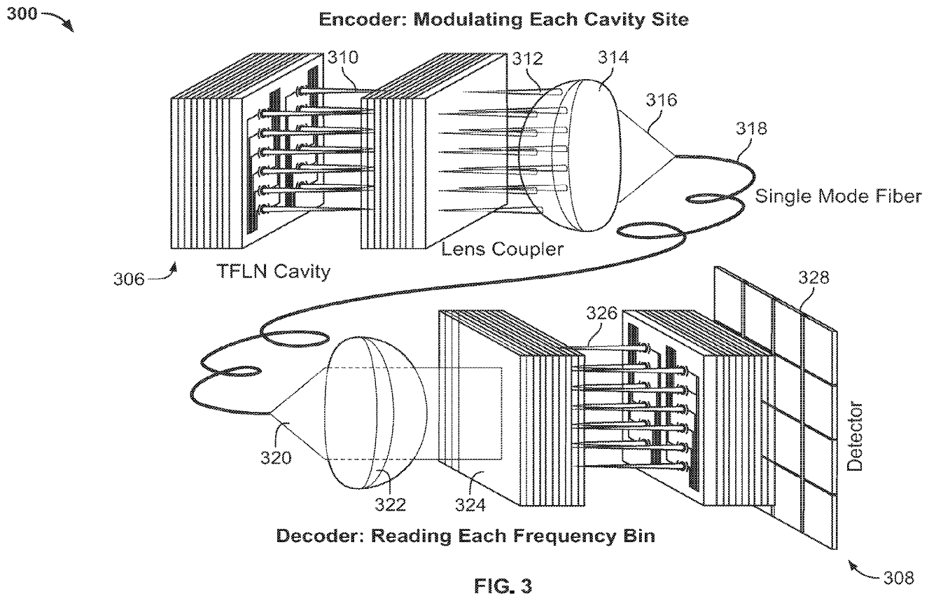

FIG. 3 shows an optical encoding system 300 using optical cavities, according to the example embodiments of this disclosure. It should be understood that the components of the system 300 shown in FIG. 3 are merely examples, and systems with additional, alternative, and fewer number of components should be considered within the scope of this disclosure.

Within the system 300, an encoder 306 may include multiple optical cavities. Each optical cavity may have a resonant wavelength 310 (having a resonant frequency). Each resonant wavelength 310 may be individually tuned, using the corresponding electrical signals in the electrodes within the thin film lithium niobate. In other words, each cavity may be modulated at the resonant wavelength/frequency and the signals to be transmitted may be encoded at that frequency. After the modulation, each output 312 may be provided to a lens coupler 314. The lens coupler 314 may combine all the outputs 312 to generate a combined output 316 to pass through a single mode optical fiber 318. This combined output 316 may achieve a tight wavelength divisional multiplexing with a relatively smaller footprint because the encoder 306 may be made smaller at least because the optical cavities have no moving parts.

The decoder 308 may be similar (e.g., a mirror image of) to the encoder 306. An input 320 from the optical fiber 318 may be separated by another lens coupler 322 as individual inputs 324 and provided to the decoder 308. The inputs 324 may resonate within the corresponding optical cavities forming resonating inputs 326. The information may be extracted from the resonating inputs 326 through a detector 328, thereby decoding the signal encoded by the encoder 306.

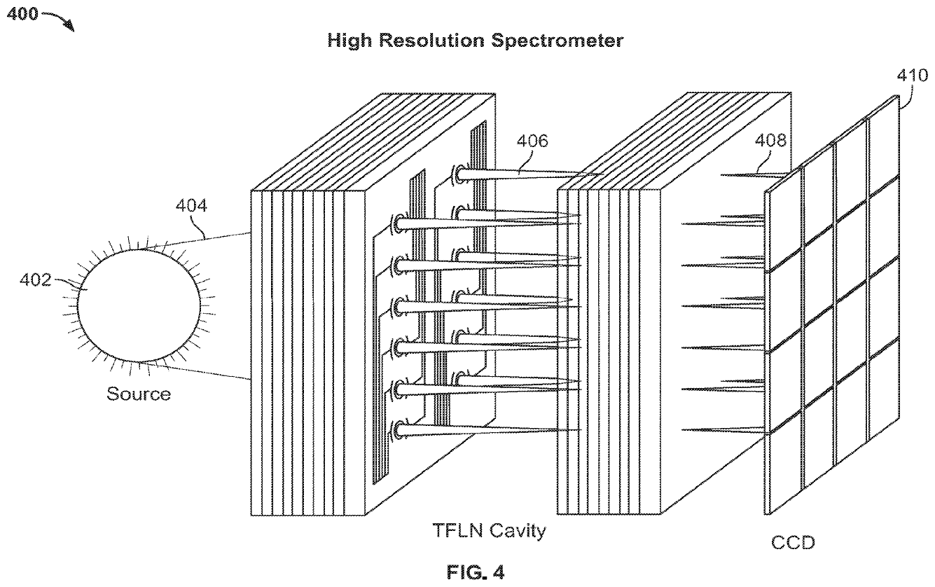

FIG. 4 shows an example high resolution spectrometer 400, according to example embodiments of this disclosure. It should be understood that the components of spectrometer 400 are merely examples, and spectrometers with additional, alternative, or fewer number of components should also be considered within the scope of this disclosure. As shown, the spectrometer 400 may be used to detect the spectral signatures of a source 402.

The source 402 may be any material (e.g., chemical compound, biological organism, etc.) that may radiate a signature spectral pattern, which may be used to identify the material. For instance, a signature spectral pattern may include a combination of wavelengths/frequencies. The spectrometer 400—with multiple individually tunable optical cavities—may be used to create a broad sweep. Furthermore, because the optical cavities may be tightly spaced (as no moving parts are involved) the resolution of the sweep can be increased significantly. That is, both the range of the sweep and the step of the sweep may be increased.

For example, an example portion 404 of the spectral pattern may be detected by resonating light 406, which may be generated as an output 408 to the detector 410. The detector 410 may then measure the spectral strength of the example portion 404.

Because the smaller footprint, the spectrometer 400 may be slipped into existing detection system. Specifically, the existing bulky spectrometers—with bulky mechanical parts—may be swapped out for the spectrometer 400.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A solid state optical cavity comprising:
a first mirror and a second mirror providing reflective surfaces for light to reflect back and forth within a cavity to create a standing wave at a resonant frequency; and
a thin film lithium niobate layer deposited between the first mirror and the second mirror, the thin film lithium niobate layer configured to be electrically tunable to optically select the resonant frequency.

2. The solid state optical cavity of claim 1, further comprising:
a first electrode and a second electrode in the thin film lithium niobate layer configured to receive an electrical tuning signal for selecting the resonant frequency.

3. The solid state optical cavity of claim 2, the first electrode and the second electrode being located at evaporated portions of the thin film lithium niobate layer.

4. The solid state optical cavity of claim 1, wherein at least one of the first mirror and the second mirror comprises a distributed Bragg reflector.

5. The solid state optical cavity of claim 1, further comprising a dielectric material.

6. The solid state optical cavity of claim 5, wherein the dielectric material comprises silicon dioxide.

7. The solid state optical cavity of claim 1, wherein the thin film lithium niobate layer is configured to be further electrically tunable to operate as a lens to change a path of light.

8. The solid state optical cavity of claim 7, wherein the change of the path is for light with non-normal incidence on the cavity.

9. The solid state optical cavity of claim 1, wherein the standing wave is generated by constructive interference of waves at the resonant frequency.

10. The solid state optical cavity of claim 1, wherein non-resonant frequencies are cancelled out through destructive interference.

11. An optical encoder for wavelength division multiplexing, the optical encoder comprising:
a plurality of solid state optical cavities for corresponding resonant wavelengths, wherein each of the plurality of solid state optical cavities comprises:
a first mirror and a second mirror providing reflective surfaces for light to reflect back and forth within the solid state optical cavity to create a standing wave for a corresponding resonant wavelength; and
a thin film lithium niobate layer deposited between the first mirror and the second mirror, the thin film lithium niobate layer configured to be electrically tunable to optically select the corresponding resonant wavelength;
wherein different signals are encoded at corresponding different wavelengths to provide wavelength division multiplexing.

12. The optical encoder of claim 11, further comprising:
a lens coupler configured to couple the different signals encoded at the different corresponding wavelengths and provide the coupled signals to an optical fiber.

13. The optical encoder of claim 11, wherein each of the plurality of solid state optical cavities further comprises:
a first electrode and a second electrode in the thin film lithium niobate layer configured to receive an electrical tuning signal for selecting the corresponding resonant wavelength.

14. The optical encoder of claim 13, wherein the first electrode and the second electrode are located at evaporated portions of the thin film lithium niobate layer.

15. The optical encoder of claim 11, wherein at least one of the first mirror and the second mirror comprises a distributed Bragg reflector.

16. The optical encoder of claim 11, wherein each of the plurality of solid state optical cavities further comprises a dielectric material.

17. An optical decoder for decoding signals with wavelength division multiplexing, the optical decoder comprising:
a plurality of solid state optical cavities for corresponding resonant wavelengths, wherein each of the plurality of solid state optical cavities comprises:
a first mirror and a second mirror providing reflective surfaces for light to reflect back and forth within the solid state optical cavity to create a standing wave for a corresponding resonant wavelength; and
a thin film lithium niobate layer deposited between the first mirror and the second mirror, the thin film lithium niobate layer configured to be electrically tunable to optically select the corresponding resonant wavelength;
wherein the wavelength division multiplexed signals are decoded at corresponding different wavelengths.

18. The optical decoder of claim 17, further comprising:
a lens coupler configured to receive coupled signals from an optical fiber and decouple the couple signals to the signals encoded at the different corresponding wavelengths.

19. The optical decoder of claim 17, wherein each of the plurality of solid state optical cavities further comprises:
a first electrode and a second electrode in the thin film lithium niobate layer configured to receive an electric tuning signal for selecting the corresponding resonant wavelength.

20. (canceled)
